(19) United States
(12) Patent Application Publication
(10) Pub. No.: US 2005/0265358 A1
(43) Pub. Date: Dec. 1, 2005

(54) Intelligent stacked switching system

(76) Inventors: Shridhar Mubaraq Mishra, Berkeley, CA (US); Pramod Kumar Pandey, Singapore (SG)

Correspondence Address: MAGINOT, MOOR & BECK, 111 MONUMENT CIRCLE, SUITE 3000, BANK ONE CENTER/TOWER, INDIANAPOLIS, IN, 46204, US

(21) Appl. No.: 10/526,811

(22) PCT Filed: Sep. 6, 2002
(86) PCT No.: PCT/SG02/00213

§ 371 Date: Mar. 4, 2005

(51) Int. Cl. H04L 12/56

(52) U.S. Cl. 370/400; 370/396

(57) ABSTRACT

A plurality of data switches such as Ethernet switches 1, 2, 3, 5 are connected to each other using their ports for receiving and transmitting packets. A given one of the switches 5 operates as a master switch, which transmits instructions to the other switches 1, 2, 3 as command packets, and receives responses back from them as response packets. The slave switches 1, 2, 3 are connected pairwise. The command packets pass through the network until they reach a slave switch 1, 2, 3 to implement them, and the response 10 packets pass through the network to the master switch 5.

### RELATED APPLICATIONS

The present rule is a group of five patent applications having the same priority date. Application PCT/SG02/______ relates to an switch having an ingress port which is configurable to act either as eight FE (fast Ethernet) ports or as a GE (gigabit Ethernet port). Application PCT/SG02/______ relates to a parser suitable for use in such as switch. Application PCT/SG02/______ relates to a flow engine suitable for using the output of the parser to make a comparison with rules. Application PCT/SG02/______ relates to monitoring bandwidth consumption using the results of a comparison of rules with packets. The present application relates to a combination of switches arranged as a stack. The respective subjects of the each of the group of applications have applications other than in combination with the technology described in the other four applications, but the disclosure of the other applications of the group is incorporated by reference.

### FIELD OF THE INVENTION

The present invention relates to methods for stacking a plurality of data switches, such as Ethernet switches, and to a plurality of data switches which are arranged as a stack.

### BACKGROUND OF INVENTION

A data switch such as an Ethernet switch transfers data packets between pairs of its ports. The number of ports of the data switch is limited, and for this reason there is often a requirement for a plurality of data switches to be “stacked”, that is to be operated as if they constituted a single switch having a greater number of ports.

Conventionally, stacking has been accomplished by assigning one of the switches to be a master switch. The CPU of the master switch sends control signals to the other switches (the “slave switches”) through a dedicated input of those switches to control them. In addition to the dedicated input required by each switch, a bus is required connected to all the switches to pass signals between the master switch and each of the slave switches.

### SUMMARY OF THE INVENTION

The present invention aims to provide new and useful methods for stacking a plurality of data switches, and arrays of switches which have been stacked.

In general terms, the present invention proposes that a plurality of switches are connected to each other using some of their ports for receiving and transmitting packets. A given one of the switches (the master switch) transmits instructions to one or more other switches (slave switches), and receives responses back from them, as data packets which pass though the network of switches.

Preferably, the slave switches are connected pairwise. The instructions to the slave switches are issued by the master switch as recognisable command packets which pass through the network until they reach a slave switch to implement them. The responses from the slave switches are in the form of response packets which pass through the network to the master switch.

### BRIEF DESCRIPTION OF THE FIGURES

Preferred features of the invention will now be described, for the sake of illustration only, with reference to the following figures in which:

FIG. 1 shows a first network of switches which is a first embodiment of the invention;

FIG. 2 shows a second network of switches which is a second embodiment of the invention; and

FIG. 3 shows a third network of switches which is a third embodiment of the invention

### DETAILED DESCRIPTION OF THE EMBODIMENTS

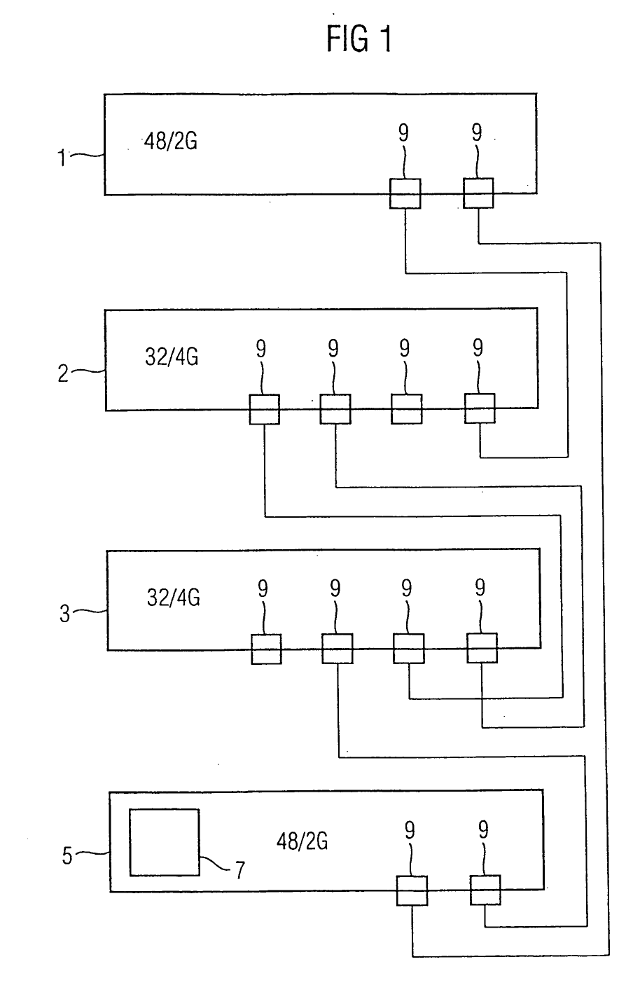

Referring to FIG. 1, a network of chips is shown which is a first embodiment of the invention. The network comprises three slave switches 1, 2, 3 and a master switch 5 having a CPU 7. The switches 1, 2, 3, 5 each have a plurality of ports, at least two of which are gigabit ports 9. Specifically, switches 1 and 5 have 2 Gigabit ports and 48 FE (fast Ethernet) ports, while switches 2 and 3 have 4 ingress/egress Gigabit ports and 32 FE ports. Each port consists of an ingress interface and an egress interface. The slave switches 1, 2, 3 are generally provided with their own CPU (not shown), known as a virtual CPU (VCPU).

Most of the-ports of the switches 1, 2, 3, 5 are normally connected to devices, but the switches are also connected to each other pairwise, with two gigabit ports of each of the switches connected to respective gigabit ports of two of the other switches. Note that the switches 2, 3 have an additional connection between a gigabit egress port of one and a gigabit egress port of the other. This is referred to as the two ports being “trunked”, so as to give effectively one port with a higher bandwidth.

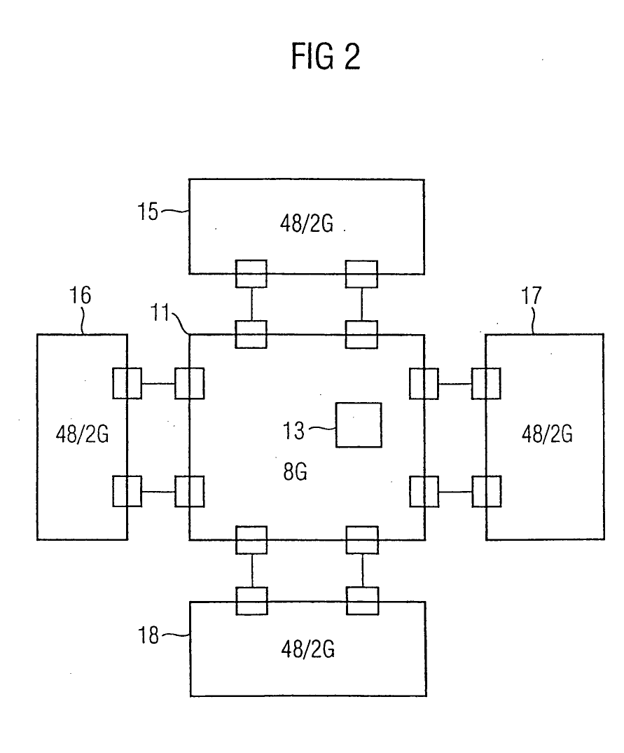

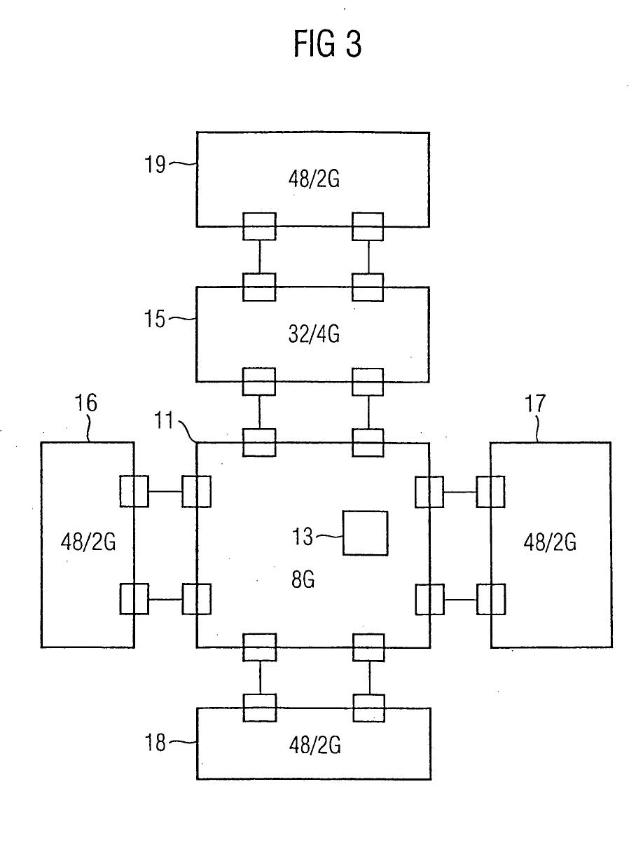

FIG. 2 shows a network of chips which is a second embodiment of the invention. In this case, the master switch 11 which is controlled by its CPU, the master CPU 13, has eight gigabit ports, and the master switch is connected using all of its ports to four slave switches 15, 16, 17, 18. Many other topologies are possible. For example, FIG. 3 shows a network of switches which is a further embodiment of the invention and which differs from the network of FIG. 2 only in that a further switch 19 is present connected to the slave switch 15, and in that the switch 15 is now a 32/4G switch having 32 FE ports and 4 gigabit ports.

The various topologies share the general feature that the slave switches are connected pairwise, either as at least one loop reaching back to the master switch (as in FIG. 1), or as up to four chain of slave switches which simply terminate (like the chain of switches 15, 19 in FIG. 3).

In the embodiments, the network is operated by the master switch issuing commands as special command data packets which the switches recognise. This may, for example, be because they carry a special MAC address in the source section of the data packet which the slave switches can recognise. Having implemented the command, the slave switches may respond by transmitting a response packet back to the master switch (e.g. if the command requires it).

Note that in FIGS. 1 and 2 there are data switches to which the master switch is not directly connected. This means that command packets and response packets pass through the network between the master switch and those slave switches via slave switches which are not otherwise directly involved in the command/response process, but simply pass on packets according to their normal operation.

For example, as described in more detail below, the master switch is preferably initially unaware of the other switches and of their topology. In a initiation stage of the network, the master switch performs a topology detection routine using a type of command packets which we may refer to as identify command packets.

The master switch 11 transmits identify command packets through all of its output ports which are designated for controlling other switches (i.e. all its egress ports in the case of FIGS. 2 and 3) asking the slave switches to identify themselves. Taking the example of FIG. 3, the first time that the slave switch 15 of FIG. 3 receives such an identify command packet, it responds to it by passing a response packet directly to the master switch 11, which recognises and interprets it so that the master switch 11 becomes aware of its existence. On the second occasion on which the slave switch 15 receives such an identify command packet, however, it passes it to the pairwise next chip 19, which generates a response packet which it passes to the slave switch 15, which passes it to the master switch 11, which interprets the response packet to learn of the existence of the slave switch 19. The master chip 11 then generates a third identify command packet and passes it to the chip 15, which passes it to the slave switch 19, which this time generates no reply (or a different reply). From the absence of a reply (or from the different reply) the master chip 11 infers that there is no further slave switch connected to the switch 19.

Once the topology of the network is established, the master chip can assign an ID to each chip, and future command packets carry this ID, thus identifying which slave chip should implement them.

The algorithms for controlling the switches will now be described in much more detail. These algorithms ensure that that the network of switches exhibit the following features:
A single CPU controls management across multiple switches.
One or two single Gigabit links for stacking (Stacking links can be aggregated)
Stack Must ensure delivery of the following kind of packets/traffic
   1. Normal Ethernet Packets (Including Jumbo frames)
   2. BPDU, GVRP & other special link constrained Multicast packets
   3. ICMP & other external multicast packets (Full size packets)
   4. Special CPU specific control packets (Register read/write etc)
   5. VLAN (per port/tagged)
   6. Port Mirroring & Port Monitoring to any switch
Topology of the stack should be identifiable, known to CPU(s) & should be possible to physically correlate the topology with the help of LEDs. Topology discovery should be capable of dynamically detecting any change in topology.
Stack management traffic should not interfere with NICs, servers & other non-infineon switches. (No leakage)
Stacking protocol must run before STP. (loops are allowed for stacking. Looped links are marked as resilient, neither the CPU messages nor the normal traffic flows through the resilient links. STP has the precedence to enable/disable resilient links).
Virtual CPU (VCPU) in each Slave CPU executes the stacking software.
Minimum changes to the Port Logic/Packet resolution & Queue manager. All intelligence for Stacking must be concentrated on the VCPU/CPU. Hence only normal ethernet packets can be used for exchanging management information & stack setup.

To provide this the embodiments of the invention operate with the following features:
l. Each Slave requires a Chip ID, which is assigned by Master CPU during topology discovery. Master has a Chip ID of 0.
2. Topology discovery must execute before Spanning tree can execute.
3. Stacking MAC Address (SMA) is available to Master CPU to send a message to any Slave.
4. Master CPU can also use the Slave's MAC Address. This message suffers less latency in each unit in the stack, which is not the target. Master CPU must ensure that an appropriate VLAN tag is assigned to such a packet such that the packet is not dropped in any Slave chip.
5. SMA is to be used for topology discovery and initial configuration setup. After initial setup, the Master CPU can switch to direct addressing to reduce latency.
6. Topology Discovery will execute each time link status of a stack port changes.

Table 1 lists all major stacking steps and/or routines.

TABLE 1
Stacking steps/routines

| Step | Description | When executed |
|---|---|---|
| Master Resolution | Elect 1 Master CPU | Whenever the topology |
| | | changes |
| Topology Discovery | Elected Master determines topology and | |
| | assigns chip IDs/MAC Addresses to all | |
| | VCPUs of Slave devices | |
| Remote Register | Master issues Read/Write for remote | When required by the Master. |
| Read/Write | registers. VCPU of slave devices | |
| | interprets the command, performs the | |
| | operations and sends a reply back to the | |
| | Master. | |
| BPDU and special | BPDU and special Multicasts are | BPDU/Special Multicasts are |
| Multicasts | encapsulated by Slave VCPU along | received by the Slave |
| | with a header and sent to the Master. | |
| MAC Table | VCPU sends “Learned and “Aged | MAC Table in slave changes. |
| synchronization | messages to Master CPU. | |
| Interrupt Processing | VCPU sends Interrupt information to | Enabled interrupt is received |
| | Master | by VCPU of slave device. |
| Monitoring | Packet to be monitored by remote | Packet to be monitored is |
| | device is encapsulated by slave device | received by VCPU of slave |
| | and sent to remote | device. |

1. Master Resolution and Topology Disco very
Topology discovery requires a special stacking packet and involves requires special processing in Packet Resolution module and Queue Manager.
DA=Stacking MAC Address (SMA)=0xAB-00-01-02-03-04
Opcode=SetID/SetIDAck/ResetID/ResetIDAck

MsgID=Message Index.

| | | | | | | | |
|---|---|---|---|---|---|---|---|
| SMA[0] | SMA[1] | SMA[2] | SMA[3] | SMA[4] | SMA[5] | SA[0] | SA[1] |
| SA[2] | SA[3] | SA[4] | SA[5] | TYPE[0] | TYPE[1] | Dest chip | OPCODE = |
| | | | | | | ID/Src | SetID |
| | | | | | | chip ID | |
| MsgID[0] | MsgID[1] | Rsv[0] | Rsv[1] | PAD | PAD | PAD | PAD |
| PAD | PAD | PAD | PAD | PAD | PAD | PAD | PAD |
| PAD | PAD | PAD | PAD | PAD | PAD | PAD | PAD |
| PAD | PAD | PAD | PAD | PAD | PAD | PAD | PAD |
| PAD | PAD | PAD | PAD | PAD | PAD | PAD | PAD |
| CRC[0] | CRC[1] | CRC[2] | CRC[3] | | | | |

Packets with DA=SMA, require special handling in PR and QM—
1. When PR detects packet with Stacking MAC Address (SMA), is applies the following algorithm to determine the destination—
   If spid=VCPU,
      Check CMAC_dest_reg to find destination.
   Else
      Send Packet to VCPU port.
   End if,
2. PR sets special bit to QM when sending Packet with DA=SMA.
3. PR learns SA of packet with DA=SMA as normal.
4. PR sets highest priority (7==CoS=4) for SMA packet.
5. PR checks critical bit of cmac_rx register to determine if packet encapsulates BPDU packet and hence must be tagged as critical to QM.
6. Fixed link aggregation bits (0) to be sent to QM for SMA packet.
7. QM uses hw_link_regsiter to determine final destination for SMA packet if stack links are aggregated.
8. If special bit is set, QM sets etag=0 in QM queue entry.
a. Master CPU must resolve Root Masters
   Root resolution uses special opcode=MasterResolution which is transferred from one Slave to the other. Master can use the ResetID message to reset IDs of any Slave.
b. Slave Discovery—Master CPU executes the following algorithm—
   Slave_id=1;
   For each stacking link (aggregated links to count as single link).
   SetMsgLoop: Send SetID message with dest_chip_ID=Slave_ID and Src_chip_ID=0;
      Wait for SetIDAck message.
      If SetIDAck msg received,
         Register slave;
         Slave_ID++;
         goto SendMsgLoop.
      // Else if SetID message is received (Ring is present) or if timeOut occurs,
      // Start processing stack link in next direction.
   End for;
   Slave VCPU executes the following algorithm when it receives any SetID message—
   If me.ID not set,
      Send SetIDAck msg with
         {DA=SMA,
         SA=own MAC address,
         Dest_chip_ID=Src_chip_ID of SetID message
            Src_Chip_ID=Dest_chip_ID of SetID message}
      Else
         Forward message to alternate stack port (if SetID message is received on Uplink port, forward to Downlink port and visa versa).
      End if;
         2. Remote Register Read/Write

Master can Read/Write Slave's registers either by using DA=SMA or DA=MAC address of remote Slave.
1. A new command cannot be sent to same Slave until Acknowledge is received for previous message or timeout occcurs.
2. Maximum writable-data per Write message=28B.
3. Maximum readable data per Read message 32B.
4. When issuing a Read opcode, CPU can use the poll or status method. Polling is generally used for Interrupt checking. VCPU does not need to respond to Poll messages unless a change has occurred in the register being read.

5. ClearWhenSet opcode is available for Master CPU to acknowledge individual interrupt bits in a register. If j^{th} bit in Data from message and j^{th} bit of regsister=1 then reset j^{th} bit in register.

Read/Write

| | | | | | | | |
|---|---|---|---|---|---|---|---|
| SMA[0] | SMA[1] | SMA[2] | SMA[3] | SMA[4] | SMA[5] | SA[0] | SA[1] |
| SA[2] | SA[3] | SA[4] | SA[5] | TYPE[0] | TYPE[1] | Dest chip | OPCODE = |
| | | | | | | ID/Src | Read/ |
| | | | | | | chip ID | Write |
| MsgID[0] | MsgID[1] | Rsv[0] | Rsv[1] | No. | Poll/Status | Rsv | rsv |
| | | | | Dwords | | | |
| Addr[0] | Addr[1] | Addr[2] | Addr[3] | PAD/ | PAD/ | PAD/ | PAD/ |
| | | | | Data[0] | Data[1] | Data[2] | Data[3] |
| . . . | . . . | . . . | . . . | . . . | . . . | . . . | . . . |
| . . . | . . . | . . . | . . . | . . . | . . . | . . . | . . . |
| . . . | . . . | . . . | . . . | . . . | . . . | PAD/ | PAD/ |
| | | | | | | Data[26] | Data[27] |
| CRC[0] | CRC[1] | CRC[2] | CRC[3] | | | | |

ReadAck

| | | | | | | | |
|---|---|---|---|---|---|---|---|
| SMA[0] | SMA[1] | SMA[2] | SMA[3] | SMA[4] | SMA[5] | SA[0] | SA[1] |
| SA[2] | SA[3] | SA[4] | SA[5] | TYPE[0] | TYPE[1] | Dest chip | OPCODE = |
| | | | | | | ID/Src | Read/ |
| | | | | | | chip ID | Write |
| MsgID[0] | MsgID[1] | Rsv[0] | Rsv[1] | No. | rsv | rsv | Rsv |
| | | | | Dwords | | | |
| Byte[0] | Byte[1] | . . . | . . . | . . . | . . . | . . . | . . . |
| . . . | . . . | . . . | . . . | . . . | . . . | . . . | . . . |
| . . . | . . . | . . . | . . . | . . . | . . . | . . . | . . . |
| . . . | . . . | . . . | . . . | . . . | . . . | Byte[30] | Byte[31] |
| CRC[0] | CRC[1] | CRC[2] | CRC[3] | | | | |

ClearWhenSet

| | | | | | | | |
|---|---|---|---|---|---|---|---|
| SMA[0] | SMA[1] | SMA[2] | SMA[3] | SMA[4] | SMA[5] | SA[0] | SA[1] |
| SA[2] | SA[3] | SA[4] | SA[5] | TYPE[0] | TYPE[1] | Dest chip | OPCODE = |
| | | | | | | ID/Src | Read/ |
| | | | | | | chip ID | Write |
| MsgID[0] | MsgID[1] | Rsv[0] | Rsv[1] | No. | Poll/Status | rsv | rsv |
| | | | | Dwords | | | |
| Addr[0] | Addr[1] | Addr[2] | Addr[3] | Data[0] | Data[1] | . . . | . . . |
| . . . | . . . | . . . | . . . | . . . | . . . | . . . | . . . |
| . . . | . . . | . . . | . . . | . . . | . . . | . . . | . . . |
| . . . | . . . | . . . | . . . | . . . | . . . | Data[26] | Data[27] |
| CRC[0] | CRC[1] | CRC[2] | CRC[3] | | | | |

3. Handling BPDU (Special Multicasts)

In every Slave, BPDUs are forwarded to local VCPU. Local VCPU must encapsulate the BPDU packet and Packet Header obtained from eDRAM into a valid ethernet packet and send it to the Master CPU. Opcode used=ENCAPforward. The format of this packet is shown below—

ENCAPforward

| | | | | | | | |
|---|---|---|---|---|---|---|---|
| SMA[0] | SMA[1] | SMA[2] | SMA[3] | SMA[4] | SMA[5] | SA[0] | SA[1] |
| SA[2] | SA[3] | SA[4] | SA[5] | TYPE[0] | TYPE[1] | Dest chip | OPCODE = |
| | | | | | | ID/Src | ENCAP |
| | | | | | | chip ID | |
| MsgID[0] | MsgID[1] | Rsv | Rsv | PH[0] | PH[1] | PH[2] | PH[3] |
| PH[4] | PH[5] | PH[6] | PH[7] | EncPkt[0] | EncPkt[1] | EncPkt[2] | EncPkt[3] |
| EncPkt[4] | . . . | . . . | . . . | . . . | . . . | EncPkt | EncPkt[n] |
| | | | | | | [n − 1] | |
| CRC[0] | CRC[1] | CRC[2] | CRC[3] | | | | |

Packet Header (PH)

| | | | | | | | | |
|---|---|---|---|---|---|---|---|---|
| 15 | 14 | 13 | 12 | 11 | 10 | 9 | 8 . . . | 0 |

| | | |
|---|---|---|
| Spid(5:0) | In_tagged | RuleID(9.0) |

| | | |
|---|---|---|
| Rsv | Crcerr | Pkt_len(13.0) |

| | | |
|---|---|---|
| I_snapped | Vlan_id(11.0) | Pri(2:0) |

Rsv(15:0)

Slave can send the encapsulated packet using DA=SMA or DA=MAC Address of CPU.

CPU executes the Spanning Tree protocol, forms a BPDU and sends this BPDU in an encapsulated frame with opcode=ENCAPreturn to the VCPU. Since the entire chip is to behave as a single switch, link cost within the stack is not taken into account. Frame format—

ENCAPreturn

| | | | | | | | |
|---|---|---|---|---|---|---|---|
| SMA[0] | SMA[1] | SMA[2] | SMA[3] | SMA[4] | SMA[5] | SA[0] | SA[1] |
| SA[2] | SA[3] | SA[4] | SA[5] | TYPE[0] | TYPE[1] | Dest chip | OPCODE = |
| | | | | | | ID/Src | ENCAP |
| | | | | | | chip ID | return |
| MsgID[0] | MsgID[1] | Rsv[0] | Rsv[1] | Dest port | Rsv | rsv | rsv |
| Rsv | Rsv | Rsv | Rsv | EncPkt[0] | EncPkt[1] | EncPkt[2] | EncPkt[3] |
| EncPkt[4] | . . . | . . . | . . . | . . . | . . . | EncPkt[n − 1] | EncPkt[n] |
| CRC[0] | CRC[1] | CRC[2] | CRC[3] | | | | |

Slave VCPU must use normal BPDU processing method to send the BPDU to the destination port specified in the ENCAPreturn packet.
   4. MAC Table synchronization
All packets that cause a change to the MAC Table are also sent to the Stacking ports.

CPU can also synchronize all MAC tables using “Learned” and “Aged” messages. Packet Resolution Module must interrupt local VCPU whenever a new MAC Address is learned or Aging occurs. This is communicated to the Master CPU by sending a packet as shown below

Learned

| | | | | | | | |
|---|---|---|---|---|---|---|---|
| SMA[0] | SMA[1] | SMA[2] | SMA[3] | SMA[4] | SMA[5] | SA[0] | SA[1] |
| SA[2] | SA[3] | SA[4] | SA[5] | TYPE[0] | TYPE[1] | Dest chip | OPCODE = |
| | | | | | | ID/Src | Learned |
| | | | | | | chip ID | |
| MsgID[0] | MsgID[1] | Rsv[0] | Rsv[1] | MA[0] | MA[1] | MA[2] | MA[3] |
| MA[4] | MA[5] | SPID | PAD | PAD | PAD | PAD | PAD |
| PAD | PAD | PAD | PAD | PAD | PAD | PAD | PAD |
| PAD | PAD | PAD | PAD | PAD | PAD | PAD | PAD |
| CRC[0] | CRC[1] | CRC[2] | CRC[3] | | | | |

Aged

| | | | | | | | |
|---|---|---|---|---|---|---|---|
| SMA[0] | SMA[1] | SMA[2] | SMA[3] | SMA[4] | SMA[5] | SA[0] | SA[1] |
| SA[2] | SA[3] | SA[4] | SA[5] | TYPE[0] | TYPE[1] | Dest chip | OPCODE = |
| | | | | | | ID/Src | Aged |
| | | | | | | chip ID | |
| MsgID[ ] | MsgID[1] | Rsv[0] | Rsv[1] | MA[0] | MA[1] | MA[2] | MA[3] |
| MA[4] | MA[5] | PAD | PAD | PAD | PAD | PAD | PAD |
| PAD | PAD | PAD | PAD | PAD | PAD | PAD | PAD |
| PAD | PAD | PAD | PAD | PAD | PAD | PAD | PAD |

5. Interrupt Processing
VCPU sends Interrupt status register to CPU on the occurrence of an enabled interrupt.

Slave can send a timer synchronized “Interrupt” message to the Master to reduce interrupt load on the Master.

Interrupt

| | | | | | | | |
|---|---|---|---|---|---|---|---|
| SMA[0] | SMA[1] | SMA[2] | SMA[3] | SMA[4] | SMA[5] | SA[0] | SA[1] |
| SA[2] | SA[3] | SA[4] | SA[5] | TYPE[0] | TYPE[1] | Dest chip | OPCODE = |
| | | | | | | ID/Src | Interrupt |
| | | | | | | chip ID | |
| MsgID[0] | MsgID[1] | Rsv[0] | Rsv[1] | IntStatus | IntStatus | IntStatus | IntStatus |
| | | | | Reg[0] | Reg[1] | Reg[2] | Reg[3] |
| PAD | PAD | PAD | PAD | PAD | PAD | PAD | PAD |
| PAD | PAD | PAD | PAD | PAD | PAD | PAD | PAD |
| PAD | PAD | PAD | PAD | PAD | PAD | PAD | PAD |
| CRC[0] | CRC[1] | CRC[2] | CRC[3] | | | | |

6. Monitoring
If monitoring port is on the same device as the Source/Destination port, algorithm used for processing packets is the same as on a standalone device.
If monitoring port is on a remote device, “monitoring port” register on local CPU is set to VCPU. VCPU must encapsulate packet and send to CPU. CPU sends packet to remote device using BPDU type encapsulation. If both Source and Destination ports of a packet are being monitored and they are on different-devices then CPU shall receive the same packet twice.
   7. Simple Unicast/Multicast Packets

Unicast/multicast messages are treated the same as on a set of switches hence no special processing is applied to normal unicast/multicast packets.

The Opcode list for the embodiments described above is as follows:

| | Message | | |
|---|---|---|---|
| Opcode Name | direction | Explanation | Code |
| MasterResolution | Master → Master | Needs to occur if two | 0x00 |
| | | stacks are connected | |
| | | together | |
| ENCAPforward | Slave → Master | BPDU to Master CPU | 0x01 |
| ENCAPreturn | Master → Slave | Master CPU sends BPDU | 0x02 |
| | | for remote port | |
| Read | Master → Slave | Master CPU issues read | 0x03 |
| | | request for Slave | |
| Write | Master → Slave | Master CPU issues write | 0x04 |
| | | request for Slave | |
| ReadAck | Slave → Master | Slave VCPU returns data. | 0x05 |
| WriteAck | Slave → Master | Slave VCPU issues write | 0x06 |
| | | Acknowledge. | |
| Error | Slave → Master | Error occurred while | 0x07 |
| | | processing Msg with given | |
| | | ID. | |
| SetID | Master → Slave | Master CPU requests first | 0x08 |
| | | Slave with no Chip ID to | |
| | | assign ID to itself. | |
| SetIDAck | Slave → Master | Slave to Master. | 0x09 |
| ResetID | Master → Slave | Master CPU requests Slave | 0x0A |
| | | to deassign Chip ID. | |
| ResetIDAck | Master → Slave | Slave to Master. | 0x0B |
| Interrupt | Slave → Master | Slave sends interrupt | 0x0C |
| | | register to Master. | |
| Learned | Slave → Master | Slave sends Learned | 0x0D |
| | | message to CPU. | |
| Aged | Slave → Master | Slave sends Learned | 0x0E |
| | | message to CPU. | |

1-4. (canceled)

5. A network of data switches, each data switch having a plurality of ports adapted for receiving and transmitting packets and arranged for transferring data packets internally between the ports of the data switches according to address information in the packets, the data switches being connected as an array, the array formed by connections between ports of pairs of the switches, the network of data switches including a master switch and other data switches, the master switch configured to issue commands to the other data switches, the commands in the form of control data packets, the other data switches comprising slave data switches configured to recognize the control data packets and to operate based on the commands contained within the control data packets.

6. The network of data switches according to claim 5, wherein the master data switch is further operable to determine a topology of the network of data switches.

7. The network of data switches according to claim 5, wherein each slave data switch is further configured implement a command within a control data packet if the slave data switch determines that the control data packet is intended to cause the command to be carried out at the slave data switch.

8. The network of data switches according to claim 7, wherein a first slave data switch is further operable to pass a control data packet from the first slave data switch to a second slave data switch if the first slave data switch determines that the control data packet is not intended to cause the command to be carried out at the first slave data switch.

9. A method of operating a plurality of data switches, each data switch having a plurality of ports adapted for receiving and transmitting packets and arranged for transferring data packets internally between ports of others of the plurality of data switches according to address information in the data packets, the method comprising:
employing at least one port of a master data switch of the plurality of data switches to issue command packets to slave data switches of the plurality of switches;
employing at least one port of each of the slave data switches to receive the command packets;
recognizing within the slave data switches the command packets and implementing commands specified in the command packets.

10. The method according to claim 9, wherein the recognizing step further comprises determining at a first slave data switch whether a command packet transmitted to the first slave data switch is intended to cause a command within the command packet to be carried out at the first slave data switch.

11. The method of claim 10 further comprising implementing the command at the first slave data switch if the first slave data switch determines that the command packet is intended to cause the command to be carried out at the first slave data switch.

12. The method of claim 11 further comprising passing the command from the first slave data switch to a second slave data switch if the first slave data switch determines that the command packet is not intended to cause the command to be carried out at the first slave data switch.

13. A method according to claim 12 further comprising:
determining at the master data switch a topology of the network of data switches.

14. The method according to claim 13, further comprising assigning IDs to the slave data switches, said IDs included in subsequent packets passing between the switches within the network of data switches.

15. A method according to claim 9, further comprising:
determining, under the control of the master data switch, a topology of the network of data switches.

16. The method according to claim 15, further comprising assigning IDs to the slave data switches, said IDs included in subsequent packets passing between the switches within the network of data switches.
